(19) United States
(12) Patent Application Publication
(10) Pub. No.: US 2024/0053160 A1
(43) Pub. Date: Feb. 15, 2024

(54) METHODS OF DETERMINING A ROUTE FOR A MOBILE USER

(71) Applicant: Continental Automotive Technologies GmbH, Hannover (DE)

(72) Inventors: Andreas Andrae, Frankfurt am Main (DE); David Gonzalez Gonzalez, Egelsbach (DE); Osvaldo Gonsa, Frankfurt (DE)

(73) Assignee: Continental Automotive Technologies GmbH, Hannover (DE)

(21) Appl. No.: 18/277,616

(22) PCT Filed: Feb. 16, 2022
(86) PCT No.: PCT/EP2022/053776

§ 371 Date: Aug. 17, 2023

(30) Foreign Application Priority Data
Feb. 17, 2021 (DE) 10 2021 201 529.8

(51) Int. Cl. G01C 21/34

(52) U.S. Cl. CPC G01C 21/3484

(57) ABSTRACT

One or more routes for a mobile user between a first location and a destination are generated and provided by composing, based on data representing roads or paths between the first location and the destination, at least one route candidate having at least one route segment. To each of the at least one route segments of the at least one route candidate one or more first values representing an estimated or predicted Quality of Experience (QoE) is assigned for one or more services or applications, executed or provided by one or more devices installed at or located with the mobile user, whose function is dependent on data that is wirelessly received in real-time or near real-time. The one or more route candidates, along with the one or more assigned first values, are processed, in, or provided to, the navigation system of the mobile user, for selection or execution.

### BACKGROUND

The present invention relates to navigation for vehicles, in particular to determining and dynamically and adaptively updating a route while navigating between a start point of the route and an end point of the route.

Today's navigation systems calculate possible routes from a start point to an end point or destination in one shot at the start point. Some navigation systems propose several alternative route types, e.g., shortest, most fuel economic, fastest, avoiding certain road types, etc., which may be user-selectable.

Static one-shot based route planning may be conceived as suboptimal, because unpredictable influences like accidents or road work along a determined route may interfere with a user's preferred route type. To address such unpredictable influences many modern navigation systems may receive real-time or near-real-time data pertaining to traffic or road conditions along route segments lying ahead. Some navigation systems rely on statistical analysis of traffic on route segments depending on the day of the week and/or the time of the day, and some navigation systems may even consider additional information such as holidays or large public events at or near route segments for determining and dynamically adapting a best route.

Passengers and systems in modern vehicles are increasingly using and relying on online services during a ride, be it for entertainment or business purposes or for proper functioning of vehicle functions. Such online services are provided to the vehicle via wireless networks, which include GSM, UMTS, LTE, 5G, Wi-Fi and other kinds of networks. However, wireless networks use shared resources, which may become congested as the number of simultaneous users within a service area of an access point increases. Also, signal strength and capacity of wireless connections may be influenced by a plethora of external factors, including signal reflexion, weather-dependent dampening of signals, permanent or transient electromagnetic interference from disturbers, etc., which may lead to fluctuation of the connection speed and capacity. In particular the network coverage of the wireless connection is generally only available from providers in a simulated or calculated context. While user-generated coverage maps exist these typically only provide signal strength information for locations and do not include network and environmental conditions that may dynamically change.

The dynamically changing network and environmental conditions may have a significant impact on a user experience of a service that relies on data provided over a wireless connection, e.g., of an entertainment service, such as video streaming or online gaming. The Quality of Experience (QoE) perceived by the user is strongly tied to the Quality of Service the serving mobile network or, more general, a certain connectivity technology can provide. The Quality of Service (QoS), or more general, the quality of connectivity depends on a multitude of factors, such as spectrum access, the availability of radio resources, the number of connected users, service types consumed by the various users, which may all vary over time and location. Besides these, environmental aspects, such as shadowing due to buildings or geographic specificities may have a location-dependent influence on the connection and thus on the QoE. However, the QoE is clearly not identical to the QoS, the latter focusing on technical aspects of the connection itself, and does not consider if a connection may be overloaded by too many connected devices or the like, which could result in a perceived low QoE despite the connection technically operating within normal parameters. Rather QoE describes a subjective or pseudo-subjective measure of a perceived quality of a service or functioning of an application. The aforementioned aspects may be referred to as dynamically changing network conditions or properties.

While many of today's vehicle navigation systems and services take temporarily impaired or closed roads and traffic density into consideration when dynamically modifying a route between a current location and a destination, the user-perceived quality of connected services used during a trip is completely ignored.

### BRIEF SUMMARY

It is, therefore, desirable to enable and/or provide a route guidance in a vehicle navigation system that is based on or at least gives some weight to a user-perceivable QoE of one or more services or applications that are active or provided at some point or time period while travelling or during the entire journey of the vehicle towards the route destination.

To this end, in accordance with a first aspect of the present invention, it is desirable to provide a method of generating and providing one or more routes for a mobile user between a first location and a destination, which one or more routes are assigned information relating to the current, predicted or estimated QoE of one or more services or applications.

It is further desirable, in accordance with a second aspect of the present invention, to provide a method of operating a mobile user's navigation system for prioritizing and/or selecting a preferred route from two or more route candidates determined in accordance with the first aspect and received at the mobile user's navigation system.

In accordance with a third aspect of the present invention it is yet further desirable to provide a mobile navigation system that is configured to execute one or more aspects of the present invention, for determining or dynamically or adaptively modifying a route for a mobile user.

In accordance with a fourth aspect of the invention it is also desirable to provide a method of determining properties or parameters of route segments that can be used in one or more aspects of the present invention.

In accordance with a fifth aspect of the invention it is yet further desirable to provide a computer system that is configured for executing one or more aspects of the present invention.

In accordance with a sixth aspect of the invention it is desirable to provide a method of generating or collecting values/data representing a pseudo-subjective or subjective user-perceived QoE for services or applications.

The aforementioned objects are achieved by the independent claims. Embodiments and improvements of the methods or apparatuses are presented in the respective dependent claims.

In accordance with the first aspect of the present invention, a method of generating and providing one or more routes for a first mobile user between a first location and a destination comprises composing, based on data representing roads or paths between the first location and the route destination, at least one route candidate. A mobile user may be a vehicle, a driver or passenger located in the vehicle, a mobile robot, a pedestrian, a cyclist and the like, that is equipped with or uses a navigation system that can wirelessly communicate with remote computers. Each one of the at least one route candidates comprises at least one route segment. A route segment may comprise one or more roads or paths. The method is characterized by assigning, to each of the at least one route segments of the at least one route candidate, one or more first values representing an estimated or predicted QoE for one or more corresponding services or applications, executed or provided by one or more devices installed at or located with the first mobile user while on the way to the route destination, whose function is dependent on data that is wirelessly received in real-time or near real-time.

In this context the first value may indicate the maximum achievable QoE for a service or an application along a respective route segment. The first value may also be determined and assigned for a time when the device executing or providing the service or application is expected to be travelling along the route segment. The maximum achievable QoE may or may not be sufficient for different subscribed service levels of an application or service, which information may be exploited in other aspects of the present invention. Also, in this context “near real-time” is meant to comprise normal buffering of received data as technically required as well as moderate pre-buffering of data that will be used by the service or application in the near future, e.g., the next few seconds. The amount of pre-buffering may depend from the type of service or application, and some services or applications may not use pre-buffering at all.

The method is further characterised by processing, in a navigation system of the first mobile user, the one or more route candidates along with the one or more assigned first values for selection and/or execution. Alternatively, e.g., when the route candidates are composed by a processing entity external to the first mobile user's device, the method may be further characterised by providing the one or more route candidates along with the one or more assigned first values to a navigation system of the first mobile user, for selection and/or execution.

The method according to the first aspect of the invention will provide one or more routes between the first location and the destination that may not be the fastest or shortest routes, but that will be less likely to provide a disappointing user-perceived QoE for services or applications that are active for or provided to a user while travelling towards the destination.

Assigning each route segment an individual estimated or predicted QoE for each service or application allows for more user-settable options that influence prioritizing and selecting of a preferred route, from the route candidates and in accordance with one or more selection criteria, in the navigation system of the mobile user, as will be discussed in greater detail further below with reference to the second aspect of the invention.

In accordance with one or more embodiments the step of composing the at least one route candidate comprises accessing a database storing data representing roads and composing at least one route candidate between the first location and the route destination based on that data. Here, the database may be local to the first mobile user, and composing route candidates may be done in a way similar to how commercially available on-board navigation systems function. Alternatively, the first location and the route destination may be transmitted to a computer that is remote to the first mobile user and that has access to a database storing data representing roads or paths, and that is configured to compose routes between the first location and the route destination. The at least one route candidate is then received in return. Composing route candidates in this alternative may be done in a way similar to how commercially available off-board navigation systems function. However, different from the known on-board or off-board navigation systems, the message may, and will typically, determine and return more than one route candidate whenever possible, because the preferred route will not be selected only based on geographical route criteria such as shortest or fastest route, or according to user-settable properties such as preferred types of roads or types of roads to avoid, which are typically static and may be provided in the request for providing route candidates. The more than one route candidate may be provided considering a maximum accepted additional length of the routes compared to the shortest route, a maximum acceptable additional energy or fuel consumption, and/or considering a maximum accepted additional travelling time compared to the fastest route. This information may be provided in the request or in a user profile.

In accordance with one or more embodiments the step of assigning first values representing a QoE for one or more corresponding services or applications comprises retrieving, for one or more services or applications, corresponding QoE values for the candidate routes or segments thereof from a database or a cloud service. While the database may be local to the mobile user or remote therefrom, the cloud service will be remote to the mobile user by definition. Retrieving may include issuing a request and receiving a corresponding response. The database, in particular the database local to the mobile user, may store data pertaining to QoE for one or more services or applications that was collected by devices installed at or located with the mobile user while travelling, but may also comprise corresponding data collected by other mobile users and that was transferred to the database at some point in time. The cloud service is more likely to store and process data pertaining to QoE that was collected by a plurality of mobile users, though data for individual mobile users may also be stored and processed in the cloud service, separate from other mobile users. The QoE values for route segments stored in the database may be different for different times of the day, days of the week and/or particular days of the year. The QoE values may, thus, be assigned in accordance with an estimated time and day at which the mobile user is expected to travel along the respective route segment. Likewise, if a time period is known during which a particular service or application will be provided or active, respectively, this may be considered when assigning first values to route segments. For example, when it is known beforehand, e.g., from a schedule or from previous trips between the first location and the destination, that a particular service or application will only be used when travelling along a final route segment, the first value for this application or service may be largely irrelevant during the first route segment(s). Such information about a service or application being provided or active only during a part of a journey may be provided in a request to the database. This may, inter alia, increase the number of route candidates that are processed in or provided to the navigation system of the first user, for prioritizing or selecting.

As an alternative to retrieving data from a database, local or remote, or from a cloud service, first values representing an estimated or predicted QoE for one or more services or applications and for one or more route segments in an area ahead of or around a current location of the first mobile user may be received from a local contributor. The local contributor may be a road side unit (RSU) or another mobile user's device that temporarily establishes a wireless communication connection with the first mobile user's device. RSUs are a part of the traffic infrastructure, typically wireless communicating devices located on the roadside, e.g., in traffic lights, lamp posts or dedicated enclosures, that provide connectivity and information support to passing vehicles, including safety warnings and traffic information. Virtual RSUs may be formed by edge computing devices that are part of 5G networks and later generations of wireless access networks. Receiving first values representing an estimated or predicted QoE for one or more route segments in an area ahead of a current location of the first mobile user may require a corresponding request or at least transmission of a direction of travel towards the local contributor, since otherwise the indication “ahead of” may be ambiguous. However, at least in case the transmission is received from another mobile user, the transmission, which is likely to only comprise data pertaining to route segments that were travelled by the respective mobile user itself, may comprise a direction of travel of the transmitting mobile user, and devices installed at or located with mobile users may stop receiving upon determining that they are travelling in the same direction and are unlikely to use the information. Receiving first values representing an estimated or predicted QoE for one or more route segments in an area around a current location of the first mobile user may or may not require a corresponding request or a transmission of a direction of travel towards the local contributor. In the latter case an unsolicited transmission, also referred to as push-transmission, may be received, and the receiving entity will determine whether and which part of the received transmission to use based on its knowledge of the remaining route between the current location and the route destination and on services or applications that are or will be available and/or active. Applications or services that will be active at some time while the mobile user is travelling towards the destination may be identified from a schedule or calendar of the mobile user. However, it is also possible to collect data about applications or services for routes frequently travelled by the mobile user and use this information for estimating future use of applications or services. One or more services or applications that will be executed or provided by a device installed at or located with the mobile user while travelling may be identified when retrieving the QoE values for the route candidates, for reducing the data that needs to be transferred. Alternatively, all QoE values for services or applications that are available for a route segment may be assigned thereto, and only those that are actually required may be considered when generating, processing, selecting or prioritizing route candidates.

In accordance with the second aspect of the invention, a method of operating a mobile user's navigation system for prioritizing or selecting a preferred route from two or more route candidates determined in accordance with embodiments of the method in accordance with the first aspect of the invention comprises receiving the two or more route candidates along with the one or more assigned first values in the mobile user's navigation system. The method further comprises retrieving user preferences for an application or service that is or will be active while the mobile user is travelling towards the destination. The user preferences may, e.g., comprise a service level that is subscribed by a user for an application or service, or a value indicating a user's expectation of a quality of experience for that application or service, i.e., an indication whether and to what extent a user tolerates disturbances or interruptions of the service or application, or other information or requirements defining a QoE expected by a user. The method yet further comprises mapping the user preferences for the application or service against the first values for each of the received route candidates, and prioritizing or selecting that route candidate as preferred route for which the first values of the largest number of route segments meet or exceed the corresponding QoE requirements provided in the user preferences.

If multiple route candidates have identical numbers of route segments that meet or exceed the QoE requirements stated in the user preferences, or if all route segments of multiple candidates meet or exceed the requirements stated in the user preferences, additional, non-QoE-related prioritizing or selection criteria may be considered, for prioritizing or selecting a preferred route, e.g., static criteria such as fastest or shortest route, or most scenic route or the like, but also information about services or applications that will be provided or active only during a certain time period of the journey. These additional criteria may likewise be stored in a file containing user preferences or otherwise received as user preferences or user input, and one or more embodiments of the method of operating a mobile user's navigation system for prioritizing or selecting a preferred route from two or more route candidates may, accordingly, further comprise retrieving one or more additional, non-QoE-related prioritizing or selection criteria from stored or received user preferences. The additional user preferences may have ranks or weights assigned thereto, for balancing their influence on the prioritizing or selection.

Alternatively, two or more routes meeting or exceeding the requirements stated in the user preferences may be presented to the user, and a selection input from the user may be received.

More than one service or application may be executed or provided at the same time, and the services or applications that are active at the same time may have different requirements as to the wireless connection. For example, the type, capacity or capability of the wireless connections of these services or applications that are active at the same time may be different. Accordingly, in one or more embodiments, the method of operating a mobile user's navigation system for prioritizing or selecting the preferred route from the route candidates may further comprise, in case more than one service or application that is executed or provided by a device installed at or located with the first mobile user and whose functions are dependent on data that is received in real-time or near real-time are active in parallel, retrieving or receiving user-determined or user-centric ranks or weights associated with each of the services or applications that are active in parallel. That route candidate, for which the value representing the estimated or predicted QoE for the service or application having the highest rank or weight has the highest value, may be prioritized or selected as the preferred route. If no user-determined or user-centric rank is provided for an application or service, a default value may be set. The default value may be the same for all users or may be determined from corresponding ranks assigned to that application or service by other users that have similar application or service profiles. In this context, applications or services that do not necessarily require real-time wireless connections or even may be paused and resumed later, such as a file download, may be assigned a lower rank or weight than an application or service that requires a real-time wireless connection, e.g., a voice or video call. The general possibility of pausing a wireless connection for a service or application, probably with a higher amount of pre-buffering prior to a drop in the QoE, may be indicated in application-specific configuration files, in user preference files or the like.

In one or more embodiments of the method of operating a mobile user's navigation system, where a preferred route is prioritized or selected at least partly based on a rank or weight assigned to a service or application, a route candidate or route segment whose first value for a service or application lies below a predetermined minimum value may be discarded irrespective of the rank or weight assigned to the service or application. This embodiment may be useful for ensuring that a minimum functionality may be provided by a service or application that had been assigned a lower rank or weight by a user, i.e., that had been ranked down, at the expense of the QoE of a service or application that had been assigned a higher rank or weight by the user. This embodiment may, e.g., be useful for ensuring at least a minimum functionality for services or applications that are essential for the safety or security of a vehicle in which the mobile user travels, in case a user is permitted to change ranks or weights assigned thereto.

In case multiple mobile users travel together, e.g., as driver or passenger in a vehicle, and each of the multiple mobile users actively uses services or applications, executed or provided by one or more devices installed at or located with the mobile users travelling together, whose function is dependent on data that is wirelessly received in real-time or near real-time, the method of operating a first mobile user's navigation system may further comprise retrieving a user-priority value for each of the users. It is obvious that only navigation system will be used in this case, e.g., a navigation system of a vehicle. When selecting the preferred route the user-priority values may be taken into account, e.g., by considering settings for services or applications in each user profile in a weighted fashion in accordance with the user-priority values. User-priority values may be stored in each mobile user's user profile. The services or applications that may be used by some or all of the multiple mobile users travelling together may be considered when generating route candidates, with or without considering the respective user-priority values and/or the ranks or weights assigned to individual applications or services.

Generally, ranks or weights for services or applications, the user-priority values, as well as other user preferences, may be stored in user profiles. A vehicle may have a user profile of its own for applications or services that are provided or executed by devices installed in the vehicle and that are used for the functioning of the vehicle. A passenger's user profile may comprise settings pertaining to those applications or services that are provided or executed by devices installed in the vehicle and that are used for the functioning of the vehicle, which settings may override the vehicle's settings. However, depending on the vehicle there may be limits for overriding.

In a development of the method of operating a mobile user's navigation system, the rank- or weight-based route prioritizing or selection may be targeted to maximize the estimated or predicted QoE for as many services or applications as possible, based on their ranks or weights. This may result in obtaining a higher estimated or predicted QoE for a service or an application not having the highest rank or weight at the expense of the estimated or predicted QoE for a service or an application having a higher rank or weight. Such selection may, e.g., be performed in accordance with user profiles or settings that represent a mobile user's preference of having multiple services or applications active in parallel even at reduced QoE over having only one selected service or application active at the highest possible QoE. In case multiple mobile users travel together, e.g., as driver or passengers in a vehicle, one or more mobile users may accept a QoE that is lower than normally preferred, in order to allow for a maximum number of mobile users travelling together to enjoy services or applications. Such information may also be stored in user profiles.

As the wireless capabilities of devices installed at or located with a mobile user may be different, and as individual services or applications may be provided or executed by different devices of the mobile user, one or more embodiments comprise retrieving data pertaining to the wireless capabilities of devices and data pertaining to the services or applications that can be provided or executed by the respective devices. Wireless capabilities may, inter alia, relate to types or speeds of connection that are available, antenna setup, receiver sensitivity, transmit power, and the like. The data may be used for weighting the first values for services or applications assigned to route segments prior to prioritizing or selecting. This embodiment may compensate for first values assigned to route segments that may not take into account the wireless capabilities of the devices providing or executing the service or application. Alternatively, the data pertaining to the wireless capabilities of devices may be used for assigning providing or executing services and applications to specific devices, in an attempt to prioritize or select a route or route segment for which the estimated or predicted QoE is maximized for a plurality of services or applications that are executed or provided by different devices. Some aspects of this embodiment may be useful, e.g., in case a vehicle has multiple devices that can receive wireless data for services or applications, where data received by one device can be locally shared with other devices that ultimately execute an application or provide a service.

In one or more embodiments individual first values for one or more services or applications may be associated with routes or route segments in accordance with different service levels or application-specific profiles. The information provided in the application-specific profiles may govern the execution or provision of the service or application between the provider and the device that executes or provides the service, including, but not limited to, specifying a type of subscription, a provider, and the like.

A service level may be linked to a certain user-perceived QoE, e.g., a certain audio quality for a streaming music service, or a certain video quality for a video streaming service. The term “quality” in this context may comprise measures such as audio or video resolution, sample rate, frame rate, accepted frame drops or distorted sound or the like, all of which have different minimum requirements towards various aspects of a wireless connection on which the service or application relies. A user who subscribed to a service or application at the highest level will be less tolerant towards a perceived QoE that does not meet the high expectations associated with the high service level than a user who subscribed to a lower service level, who may be more tolerant. Accordingly, the route for a user having subscribed to a high service level may be different from the route for a user having subscribed to a lower service level, depending on the first values representing an estimated or perceived QoE for different service levels. Likewise, a route for a user having subscribed to a service or application that wirelessly receives data from a first provider may be different from the route for a user having subscribed to the same service or application that receives data from a second service provider, even if both users have subscribed the same service level. One reason for this is that the wireless coverage of the service providers in general can differ significantly, and the coverage with data connections offering speed, latency, etc. as required by a service or application may differ even more.

Other measures for expressing a quality than those discussed above may be used, depending on the service or application. For example, when a service for autonomous driving requires data transmission in real time, the service may be available in different service levels. At the highest service level, the amount of data that is analyzed and processed may be very large, and a large portion thereof may be processed off-board. This service level may provide a very smooth ride, without abrupt changes of direction and speed, mainly due to the larger amount of information pertaining to the vehicle's environment that is processed, which may additionally use other vehicles' sensor data and thus look farther ahead for identifying upcoming situations. A lower service level may, e.g., analyze and process a lower amount of data, possibly only from sensors installed in the vehicle, and to a lower extent process these data off-board, and may consequently ever so often need to abruptly change direction or speed, due to objects or environmental situations that were not yet analyzed and processed, and that could only be considered by the vehicle after the vehicle's local sensors and analysis were capable of detecting the objects or situation. It is readily apparent that a driver who has opted for the higher service level which may require a stable high-speed wireless connection, has a different view as to what a high, moderate or poor QoE will be, than a driver who has opted for a lower service level, who will accept, e.g., a lower level of automated driving functions, which may include lower driving speeds or a generally lower level of automated driving, and may have other priorities.

Accordingly, the method of operating the mobile user's navigation system for prioritizing or selecting a preferred route from the route candidates comprises retrieving, for one or more services or applications, a service level and/or application-specific profile. The information comprised in the service- or application-specific profiles may be used for selecting, for each received route candidate or segment thereof, one or more first values in accordance with a service level and/or an application-specific profile of the respective services or applications that are or will be active while the mobile user has not yet reached the destination. The prioritizing or selecting of the preferred route will then be based on the appropriate first values for the service level or in accordance with other information from the application- or service-specific profile.

In one or more embodiments of the method the route may be adaptively or dynamically modified while the vehicle is still on the way to the destination, similar to known methods for modifying routes based on updated traffic information. However, in accordance with the present method, the route is modified based on updated information pertaining to first values representing estimated or predicted QoE for one or more corresponding services or applications for route segments lying between a current location of the vehicle and the route destination. The method accordingly comprises retrieving or receiving, while the vehicle has not yet reached the destination, updated information pertaining to first values representing estimated or predicted QoE for one or more corresponding services or applications for route segments lying between a current location of the vehicle and the route destination.

The updated information may be retrieved or received in one of the ways described further above, e.g., by accessing a database or a cloud service, or through a local contributor. Updated information may be retrieved from a cloud service by issuing corresponding requests in regular intervals or in response to particular events. Such event may comprise unexpected events, e.g., a QoE for a current route segment unexpectedly not matching the estimated or predicted QoE for a time period that is longer than a predetermined uninterrupted time period or an incoming audio or video call. Such event may also comprise scheduled events, e.g., a video call scheduled for a time at which the vehicle has not yet reached the route destination. The latter case may occur in particular when the mobile user will not or has not reached a route segment as was planned in a previously selected preferred route, e.g., due to slow traffic or traffic-related detours. The latter case may also occur when, at the time of the scheduled event, the mobile user has already passed a route segment that was planned in a previously selected preferred route for the time of the scheduled event, and which would have provided a desired QoE, e.g., due to less traffic than predicted. Updated information may be provided in accordance with a subscription for an application or service which determines, e.g., the frequency of push-updates and the like. Details on how and when updates are sent may be stipulated in a user profile and/or subscription.

Generally, and in particular upon receiving updated information pertaining to first values representing estimated or predicted QoE for one or more corresponding services or applications for route segments lying between a current location of the first mobile user and the destination in accordance with this embodiment, the method may repeat the determining step for determining route candidates between a current location and the route destination, and will repeat the assigning step using the updated information. Finally, the method according to this embodiment will repeat the selecting step, for selecting an updated preferred route.

When combined with other embodiments described further above, in which user preferences are considered when selecting a preferred route, this embodiment may even direct the mobile user to a place where the mobile user may safely be stationary, and where a specific type of wireless connection is available, when a scheduled event occurs. For example, a mobile user that is significantly behind schedule may need to make a video call, and the data plan associated with the corresponding device that runs the service is insufficient for supporting video calls. The method may then modify the route to a place that provides a free Wi-Fi connection known or at least expected to provide sufficient bandwidth. Such places may include locations of restaurant chains, gas stations and the like that are known to normally provide free Wi-Fi.

In accordance with a third aspect of the present invention, a mobile navigation system comprises at least one microprocessor, a volatile memory, a non-volatile memory, a location receiver and at least one communication interface. The location receiver may be configured to operate using signals from global navigation systems such as GPS, GLONASS, Baidu, Galileo and the like. Other geo-location services may also be used, including geo-location based on Wi-Fi signals, LORAN-based systems and the evolution thereof, and the like. The communication interface is adapted to communicate with a database, a cloud service and/or other vehicles, inter alia for receiving first values representing QoE values for route segments and/or route segments that are assigned such first values. The non-volatile memory stores computer program instructions which, when executed by the at least one microprocessor, configures the mobile navigation system to execute one or more methods, or embodiments thereof, in accordance with the first or second aspect of the invention.

In accordance with a fourth aspect of the present invention a method of determining one or more first values representing an estimated or predicted QoE for a service or application for a route segment comprises receiving, from a plurality of devices of mobile users that are executing or providing, or had executed or provided, one or more services or applications while travelling along the route segment, values or data representing a perceived, experienced or otherwise determined QoE pertaining to the respective services or applications for the route segment or for locations along the route segment. Optionally, a time and/or a date of the collection of the values or data, connection data describing the wireless connection used for receiving or transmitting data that was required for executing or providing the application or service, device data describing properties of the transceiver used for establishing and maintaining the wireless connection, the type and placement of the transceiver antenna, user profile data describing, inter alia, a subscribed service level, a subscription type and other data or user settings and/or preferences defining or controlling the functioning of respective services or applications, and/or other sensor data collected by one or more sensors installed at or located with a respective one of the devices including, but not limited to, weather information and travelling speed may be received from the plurality of devices. The connection data may include, inter alia, a link type, a link ID, a communication protocol or standard used, a frequency or channel used for communicating, and the like. Further optionally, traffic, environmental and/or social data may be received from other sources not located with the mobile users or the devices. Social data may, e.g., include information about holidays, events near a route segment and the like, which may indicate a larger number of devices being attached to wireless access points of wireless networks, or a higher traffic being served by backbone networks in a region. The data and information listed above, that may be optionally or additionally be used for determining first values, may be dubbed meta-information, i.e., information that may not necessarily be directly related to the data that is actually used for providing the service or executing the service. The method further comprises analyzing and merging the values or data received from a plurality of devices and, if available, the optionally received data and other information into classified sets of QoE values. The classified sets of QoE values may include subsets for different service levels of applications or services.

In an embodiment of the method in accordance with the fourth aspect of the present invention further comprises determining a number of mobile users or devices that retrieve first values representing an estimated or predicted QoE for one or more services or applications and that are or are expected to be travelling route segments at the same time or within a predetermined time window. Accordingly, analyzing and merging the received values, data and/or other information further comprises reducing a predicted or estimated QoE, for one or more service levels, wireless providers, device and/or transceiver types, of one or more services or applications for a route segment for which the number of mobile users or devices that are or are expected to be traveling at the same time or within a predetermined time window exceeds a predetermined value.

This embodiment of the method is targeted to considering the number of currently active routes in a given area or region when determining estimated or predicted QoE, and to distributing the mobile users or devices over alternative routes that are known to be served through different wireless access points and/or connection types in accordance with settings and parameters that are ultimately set or determined by a user. In this context, even the choice of a provider, of a service level or of a device type may be considered a parameter that is set or determined by a user. Routing the mobile users or devices via different routes may help avoiding local network congestions that will inevitably result in reduced QoE. This embodiment may allow for the server or database or, more generally, computer system that provides the first values, to actively balance the use of resources available along a plurality of routes.

While this may appear rather Darwinist at first glance, considering these parameters may actually result in users having subscribed to a low service level sharing the same road segment with users having subscribed to the highest service level. For example, a wireless network along a route segment may only have a capacity sufficient to serve one user having subscribed to the highest service level, but may still have sufficient capacity for serving one or multiple users having subscribed to a lower service level or users that accept more or less frequent intermittent reductions of the perceived or experienced QoE. This distribution may depend on the service or application and may also depend on the respective connection requirements for different service levels.

In accordance with a fifth aspect of the present invention, a computer system has access to a database storing, inter alia, road or path data, and is wirelessly connected or connectable with a plurality of mobile users or devices that are configured to transmit localized and time-stamped feedback pertaining to experienced, perceived or mathematically determined QoE of one or more services or applications, whose operation relies on data wirelessly received through a communication network, irrespective of the network type or technology, collected while travelling along route segments of a route. The computer system is configured to execute the method, or variants thereof, in accordance with the fourth aspect of the present invention.

In accordance with the sixth aspect of the present invention the feedback pertaining to the experienced or perceived QoE may comprise what can be referred to as pseudo-subjective or subjective user-perceived QoE, depending on the mechanism and the metric used for collecting the feedback. Subjective feedback may be collected, e.g., by directly interfacing with the user, e.g., requesting a star or other rating of a service or application. Pseudo-subjective feedback may be obtained from analyzing and evaluating user actions in connection with the service or application in connection with objectively measurable parameters. For example, when a user pauses or terminates a service at a point in time when objective parameters of the wireless connection suggest that the function of the service or application may be impeded. The analysis and evaluation of the pseudo-subjective feedback may employ an artificial intelligence or a machine learning process. The subjective feedback, or user actions usable in determining pseudo-subjective feedback, may be received via a user interface. A user profile may also be retrieved, and the feedback may be processed in accordance with a user profile for the respective service or application, and may be locally stored and/or transmitted, optionally along with the information from the user profile, to the computer system in accordance with the fifth aspect of the invention.

Interfacing with the user for collecting feedback may comprise presenting or activating, for a respective service, a user input field on a touch screen or a button, in regular or user-settable intervals, when a service or application is terminated, or when a parameter of a wireless connection used for receiving or transmitting data required for the functioning of the service or application falls below a predetermined value. At the predetermined value the wireless connection may still be good enough to be compensated, i.e., a user may not notice a deterioration of the service or the functioning of the application, or the user may have noticed a service degradation or a degradation of the functioning of the application while the service or the application are still available at a lower quality or service level.

A computer program product comprises computer program instructions which, when executed by a computer, cause the computer to execute the methods in accordance with one of the methods according to aspects of the invention presented hereinbefore.

The computer program product may be stored on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

In accordance with one or more aspects of the methods presented hereinbefore, even if multiple vehicles are or will be travelling between the same first location and destination, each of these vehicles may be following different route segments, depending on the applications or services that are provided to users or passengers in each one of the multiple vehicles.

To this end, one or more route candidates are created in a map, that are enriched with user- and application or service-specific data representing estimated or predicted QoE for all route segments of each route candidate. The route segments in the map may further be enriched with environmental data, vehicle- and wireless technology-related data. The data may be provided by a cloud server. While travelling, similar data may be collected in each vehicle and transmitted to the cloud server, preferably for all applications or services active throughout parts of or the entire journey, for aggregating and further enhancing future estimation and prediction. The prediction may, thus, be optimized under spatio-temporal and vehicle-type or -equipment related aspects. QoE-related feedback may be collected via corresponding user input that may be collected, e.g., through user interfaces provided in the vehicle or on a device, at regular intervals or in response to trigger events. QoE-related feedback may be collected through textual assessment or in accordance with other known rating schemes, e.g., assigning a number of stars or grades.

Even if the same services or applications are presented to or executed for users or passengers in different vehicles travelling from the same first location to the same destination the respective vehicles may travel different route segments, depending on the user profiles of the users or passengers, which may comprise different service levels, indicate different levels of acceptance of degradations of QoE, or the like. For example, when a navigation system retrieves the first values representing QoE values for various services or applications from a remote database, it may send the required QoE for each application or service along with the request. The database will only provide this information for those route segments in return, which are estimated or predicted to just about fulfil the requirements. Information for any route segment that exceeds the QoE requirements by a predetermined margin will not be transmitted or will only be transmitted in case the next best alternative route or route segment would result in a significant detour or in a significantly longer travel duration.

Likewise, in case a large number of requests to the same routes or route segments is received for the same time periods or largely overlapping time periods, the database may return QoE values for different alternative route segments to different vehicles, for distributing the load on the wireless network along respective route segments, and/or to differentiate between different subscribed service levels, as the load on the network along a route segment obviously has a significant effect on the achievable QoE for each attached mobile entity.

To this end, the database may establish and maintain information about a communication capacity for each route segment. The communication capacity may indicate the highest number of mobile entities that can be attached to base stations of the wireless network, irrespective of the type or technology, along a route segment at any time, a maximum data rate for each individual communication link or for all communication links that can be served in parallel from each respective base station, the latter being largely dependent on the backbone connection of the mobile network's base stations. A current or predicted network load for each route segment may be determined based on the requests for first values for the respective route segment. Additional information may be received from mobile network operators. The additional information may include data indicating a number of other users that are using a network resource along route segments, which other users did not request QoE data from the database.

The database may also receive feedback about the perceived QoE from a plurality of users or passengers that travel along route segments, irrespective of whether the users or passengers are located in vehicles that follow a route presented by a navigation system or not. The feedback about the perceived QoE may be received in real-time or near real-time, and may be combined with other data such as date, time of the day, weather data, holidays, local events from which network load conditions may be deduced and the like, for improving the estimated current QoE and predicted QoE. Real-time or near real-time feedback of perceived QoE may be used for modifying preferred or prioritized routes or route segments thereof that had previously been determined or selected. To this end the database may push-notify updated first values for route segments identified in a previous request to the respective vehicle's navigation system. The vehicle's navigation system may then determine whether to modify the preferred or prioritized route. This may function in a way similar to traffic-dependent rerouting, of which many of today's vehicle navigation systems are capable. If the at least one route candidate for a vehicle was determined off-board, i.e., in the database or a server connected thereto, the database or server connected thereto may push-notify at least one modified route candidate to the vehicle's navigation system, for prioritizing or selecting in accordance with information or input that is available only locally. An alternative updating or modification procedure may be initiated by the vehicle navigation system in response to an input signal that represents a perceived QoE which is below the passenger's or user's expectation.

The present invention extends the capabilities of known navigation systems, which may calculate routes with respect to travel time, distance and fuel-economy, through using real-time or near real-time connectivity data for determining and providing individualized routes for users that provide optimized connectivity and QoE for specific applications and services that rely on data that is wirelessly provided. The use of current connectivity and usage data avoids uncertainties associated with predictions based on historic and possibly temporally and locally sparse connectivity data, and also permits dynamic adaptation of routes based on unpredictable usage of networks.

The present invention also advantageously makes use of user profiles that provide information about user expectations with regard to QoE for individual services and applications, which allows for an equalized or balanced distribution of users across alternative routes, and which may help avoiding network congestion.

Collecting information about perceived QoE from individual users for locations along routes travelled, along with the users' QoE expectations for various applications and services, and optionally enhanced by further information such as weather, date and time, may help improving the prediction of QoE and may also allow for a higher responsiveness in dynamically adapting routes for other users. Updated QoE information and/or routes may be transmitted using push notifications or requested in an event-based fashion, e.g., before reaching a possible bifurcation of a route into alternative route segments, thereby permitting quick reaction to unpredicted changes in connectivity on route segments lying ahead.

The methods presented hereinbefore, and the apparatuses implementing the methods, may be used for a service, preferably a cloud-based service, which provides QoE-based navigation or route provision service. Users who subscribe to the service will use a client implemented in software running on a personal mobile device or a device located in a vehicle that provides a navigation function and that has a wireless communication interface. The wireless communication interface is configured to request and/or receive localized data representing an actual, estimated or predicted QoE for one or more applications or services whose function relies on data wirelessly received in real-time or near real-time.

Alternatively, or in addition, the methods presented hereinbefore, and the apparatuses implementing the methods may be used in a system that relies on localized data, which was collected and aggregated by, and maintained in a local database of, a vehicle or a general mobile device while travelling along routes, which data represents a QoE for one or more applications or services, whose function relies on data wirelessly received in real-time or near real-time.

Localized data representing QoE for one or more applications or services whose function relies on data wirelessly received in real-time or near real-time, which data was collected and aggregated by, and maintained in a database of, a vehicle, may be shared with other vehicles or users through means of direct or indirect communication. Such direct or indirect communication between vehicles is generally referred to under the abbreviation V2X or C2X, for vehicle-to-X or car-to-X. Other short-range communication means for direct or indirect communication between users may include ad-hoc Wi-Fi communication under the IEEE 802.11ad standard, Bluetooth-based communication and the like. Indirect communication may be established via road side units (RSU) or through a mobile edge computing infrastructure. RSUs or mobile edge computing infrastructure may also be leveraged for locally storing, analyzing and providing or relaying data representing QoE for one or more applications or services, whose function relies on data wirelessly received in real-time or near real-time. Locally sharing the data representing QoE is a fast way for updating users in the same area, allowing them to update or adapt their routes in case of unpredicted network connectivity conditions.

Localized data representing QoE for one or more applications or services whose function relies on data wirelessly received in real-time or near real-time, which data was collected and aggregated by, and maintained in a database of, a vehicle, may also be uploaded to a backend system, e.g., a cloud server, for further collection, aggregation and analysis. Not only can the data be used for providing navigation-related services to users or subscribers, but also for informing wireless network operators about loci having poor network performance that result in poor QoE.

In essence, the vehicle will be primarily guided by the perceived QoE, where QoE may be assessed based on real-time, e.g., measured or reported, as well as stored, e.g., historic, QoE-related data. The accordingly proposed or selected navigation routes may lead to increased travel time or distance, however with maximized user experience of in-vehicle services or applications that rely on wirelessly transmitted data. A route proposing an increased distance may be prioritized or selected only if the available energy will be sufficient to travel such route. This may invoke checking the battery level or filling level of a fuel tank. The underlying optimization scheme allows for tuning the determination and selection of route candidates, i.e., trade-offs with respect to QoE vs. travel time increase are configurable.

### BRIEF DESCRIPTION OF THE DRAWINGS

In the following section exemplary embodiments or implementations of invention will be further described with reference to the drawings.

FIG. 1 shows an exemplary flow diagram of a method in accordance with the first aspect of the invention.

FIG. 2 shows details of embodiments of one step of the method shown in FIG. 1.

FIG. 3 shows details of embodiments of another step of the method shown in FIG. 1.

FIG. 4 shows an exemplary flow diagram of a method in accordance with the second aspect of the invention.

FIG. 5 shows an exemplary block diagram of a vehicle navigation system or otherwise mobile navigation system in accordance with a third aspect of the present invention.

FIG. 6 shows an exemplary message flow diagram, or swim-lane diagram, during execution of methods, or embodiments thereof, in accordance with the present invention.

FIG. 7 shows the functioning of the invention in a first simplified, schematic and diagrammatic real-world example.

FIG. 8 shows the functioning of the invention in a second simplified, schematic and diagrammatic real-world example.

FIG. 9 shows the functioning of the invention in a third simplified, schematic and diagrammatic real-word example.

In the drawings, identical or similar elements may be referenced using the same reference designators.

### DETAILED DESCRIPTION

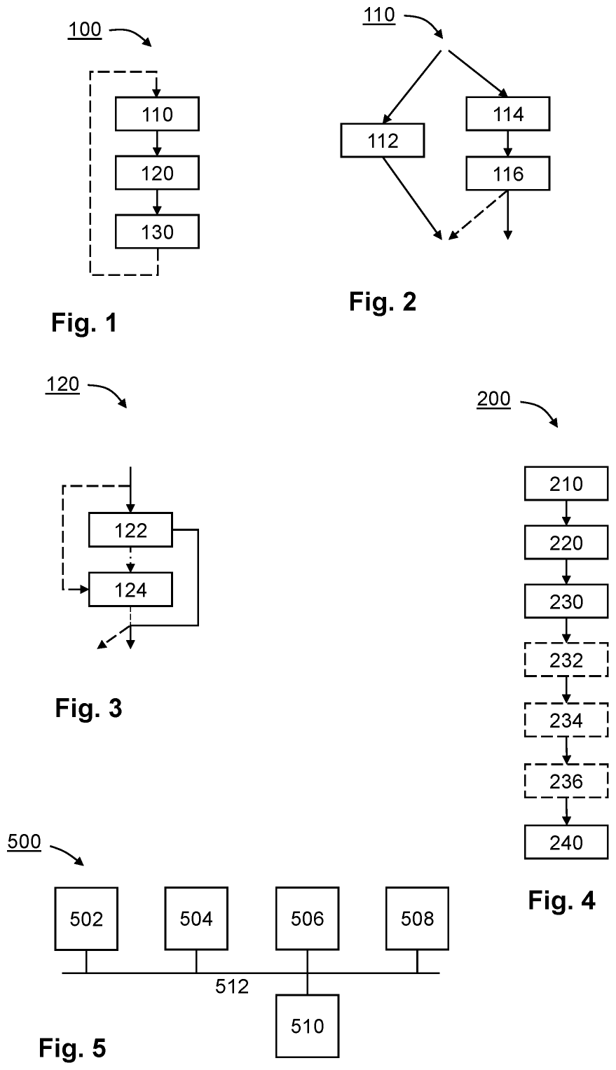

FIG. 1 shows an exemplary flow diagram of a method 100 of generating and providing one or more routes for a first vehicle between a first location and a destination in accordance with the first aspect of the invention. In step 110 at least one route candidate is composed, based on data representing roads between the first location A and the destination B. The at least one route candidate comprises at least one route segment. Composing the route candidates may be done in a conventional manner generally known to the skilled person. In step 120 one or more first values representing an estimated or predicted QoE for one or more corresponding services or applications, executed or provided by one or more devices installed or located in the first vehicles 1, 2, 3, 4, whose function is dependent on data that is wirelessly received in real-time or near real-time, are assigned to each of the at least one route segments of the at least one route candidate. In step 130 the one or more route candidates, along with the one or more assigned first values, are processed, in, or provided to, a navigation system 500 of the first vehicles 1, 2, 3, 4, for selection and/or execution. The method steps may be repeated as required, indicated by the dashed arrow.

FIG. 2 shows details of embodiments of step 110 of the method shown in FIG. 1. The step can essentially branch into two paths, depending on whether the route candidates are determined locally in the first vehicles' 1, 2, 3, 4 navigation systems or in a remote computer. In step 112 of the left branch, the route candidates are determined locally in the first vehicles' 1, 2, 3, 4 navigation systems. Accordingly, the step comprises accessing a database, local to the first vehicles 1, 2, 3, 4, that stores data representing roads, and determining at least one route candidate between the first location A and the destination B using that data. In step 114 of the alternative right branch, the first location A and the destination B are transmitted to a computer remote of the first vehicles 1, 2, 3, 4 that has access to a database storing data representing roads, and that is configured to compose at least one route candidate between the first location A and the route destination B. In the subsequent step 116 the at least one route candidate is received at the first vehicles 1, 2, 3, 4, indicated by the dashed arrow pointing down and left, for use in step 120, when executed locally in the first vehicles 1, 2, 3, 4. Alternatively, the at least one route candidate is received by a process executing step 120 of the method in the remote computer, indicated by the solid arrow pointing straight down.

FIG. 3 shows details of embodiments of step 120 of the method shown in FIG. 1, in which one or more first values representing an estimated or predicted QoE are assigned to each of the at least one route segments of the at least one route candidate. This step may be executed in the navigation systems of the first vehicles 1, 2, 3, 4 or in the remote computer. Accordingly, the input to step 122 may comprise the route candidates from the respective first vehicle's 1, 2, 3, 4 navigation system, e.g., from step 112 of FIG. 2, or from the remote computer, e.g., step 116 of FIG. 2. In step 122 corresponding first values representing an estimated or predicted QoE for the candidate routes or segments thereof, for one or more services or applications, are retrieved from a database or a cloud service. Retrieving the first values from the database may include sending a corresponding request to the database, in which the route candidates or the corresponding route segments are identified. The retrieved first values are then assigned to the route segments, and the method may output the route segments with the assigned first values, e.g., for further processing in step 130 of the method shown in FIG. 1, as indicated by the solid arrows. Alternatively, or additionally, first values may be received, in step 124, from a local contributor. The alternative flow of the method steps is indicated by the dashed arrows. The dash-dotted arrow connecting steps 122 and 124 indicates the message flow in case both steps 122 and 124 are executed.

FIG. 4 shows an exemplary flow diagram of a method 200 of operating a vehicle navigation system for prioritizing or selecting a preferred route from two or more route candidates determined in accordance with the method 100 described with reference to FIGS. 1 to 3. Steps of method 200 may be part of or overlap with the processing step 130 discussed further above. In step 210 the two or more route candidates along with the one or more assigned first values are received in the first vehicle's 1, 2, 3, 4 navigation system. In step 220 user preferences for an application or service that is or will be active while the first vehicle 1, 2, 3, 4 is travelling towards the destination B are retrieved. The user preferences may be retrieved from a memory or database through a corresponding request. In step 230 the user preferences for the respective application or service are mapped against the first values for each of the received route candidates. In step 240 that route candidate is prioritized or selected as preferred route, for which the first values of the largest number of route segments meet or exceed the corresponding information provided in the user preferences. If all route segments of more than one route candidate meets or exceeds the requirements set in the user preferences, further selection criteria may be retrieved, in optional step 232, or the route candidates may be presented to the user for manual selection optional step 234. If more than one service or application is or will be at least temporarily executed in parallel while the first vehicle is travelling towards the destination B, ranks or weights associated with each of the services or applications that are active in parallel may be retrieved, in optional step 236, for consideration during prioritizing or selecting.

FIG. 5 shows an exemplary block diagram of a vehicle navigation system or otherwise mobile navigation system in accordance with a third aspect of the present invention. The navigation system 500 comprises a microprocessor 502, a volatile memory 504, a non-volatile memory 506 and at least one communication interface 508, and a component 510 for determining a geo-location, which are communicatively connected via at least one data connection or bus 512. The non-volatile memory 506 stores computer program instructions which, when executed by the microprocessor 502, cause the vehicle navigation system 500 to at least execute parts of the methods according to the first and/or second aspect of the present invention as presented above.

FIG. 6 shows an exemplary message flow diagram, or swim-lane diagram, during execution of methods, or embodiments thereof, in accordance with the present invention. The messages are sent and received between a navigation system and a server, and between the server and a database. The navigation system may comprise a user interface or other interface for entering or receiving a destination B for an impending trip and may also comprise means for determining a current geo-location. The navigation system may also comprise map data representing roads. The server may be configured to determine candidate routes between a first location A and a destination B, or to receive route candidates and/or the corresponding route segments. The server may further be configured to access a database that retrievably stores first values representing QoE for route segments. In case of an off-board navigation, the navigation system may transmit a location and a destination to the server. The server may request and receive road data from the database and determine route segments of one or more route candidates. Alternatively, in case of an on-board navigation, the navigation system may locally determine and transmit information about roads or route segments of route candidates to the server, as indicated by the dashed arrows. The server may determine a time, day, traffic and the like, for each of the route segments, at which the vehicle is likely to travel along respective route segments. Some of the information may also be provided by the vehicle in the request to the server. Next the server requests and receives QoE for the roads or route segments, in accordance with optional information like day and time etc. When the roads or route segments are locally determined in the navigation system, and when the assignment is executed in the navigation system, the QoE for the roads or route segments may be transmitted to the navigation system, which accordingly performs the assignment. Otherwise, the server assigns the QoE to the roads or route segments determined by the server, generates the route candidates, and transmits the route candidates and the assigned QoE to the navigation system. The navigation system may than execute the route guidance, or select, in accordance with other selection criteria, or present for user selection, multiple route candidates.

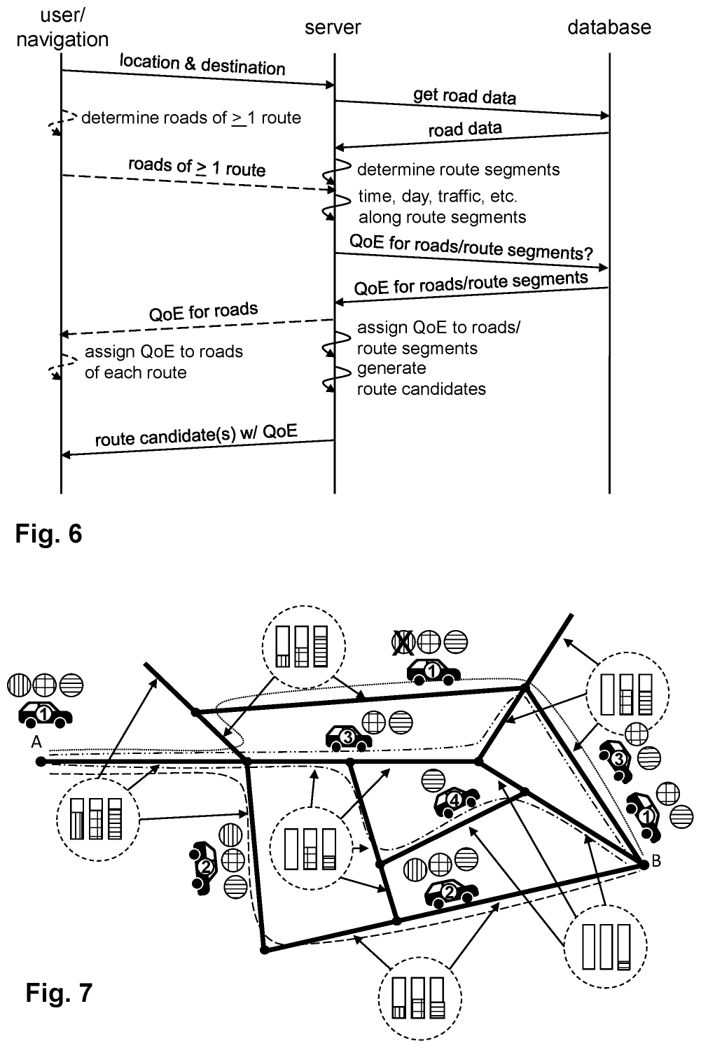

FIG. 7 shows the functioning of the invention in a first simplified, schematic and diagrammatic real-world example. In the figure a network of roads connecting, inter alia, points A and B is shown. Several roads bifurcate or intersect, and various routes are possible for going from point A to point B, differing at least in some route segments. In the example, four vehicles 1, 2, 3, 4 all travel from point A to point B. The four vehicles 1, 2, 3, 4 are shown at different times, and some are shown at different positions throughout their respective journey, for clarity reasons. The routes taken by the vehicles are indicated by the respective different dotted, dashed or dash-dotted lines. While travelling, each of the vehicles may use one or more of three different services or applications. The patterned circles next to a vehicle show which of the three applications is actually active in each vehicle during the journey. Along each road or route segment wireless connectivity may be available that supports different levels of QoE for each of the three applications or services. Not all of the route segments have identical estimated or predicted QoE for all services or applications. The estimated or expected or predicted QoE for each road or route segment is indicated by the bar-graph indicators showing the corresponding pattern.

All three applications or services are initially active in vehicle 1, and one of the services will be terminated according to a schedule during the journey, e.g., a telephone or video call, or a streaming service that will be ended according to a schedule. The scheduled end is indicated by the crossed-out service next to the vehicle. In vehicle 2, all services or applications are active during the entire journey. In vehicle 3 only the services represented by the crossed-line pattern and the horizontal-line pattern are active during the entire journey. In vehicle 4 only the service or application represented by the horizontal-line pattern is active during the entire journey.

The routes for all vehicles could theoretically be identical, since at least one route, the one followed by vehicle 2, supports all services or applications at all times. However, as indicated by the bar-graph for the service represented by the vertical-line pattern, the capacity of the wireless connection is sufficient only for a limited QoE, and this may not be sufficient for supporting the service or application in multiple vehicles simultaneously. A server, not shown in the figure, that is contacted by the navigation systems of all of the vehicles, is aware of this fact, and consequently transmits different expected QoE for some route segments to vehicle 1 and vehicle 2. For example, the server may transmit to vehicle 1 a low QoE value for the route segment pointing down at the first intersection, while it may transmit a sufficient QoE value to vehicle 2. The navigation system of vehicle 1 will then avoid that route segment and select or prioritize the one pointing up. The route segment going straight at the intersection is excluded anyway, since the estimated or predicted QoE value for the service or application represented by the vertical-line pattern is too low. This distribution of different QoE values to different vehicles going from the same starting point to the same destination, for influencing the choice of routes taken, thus provides both vehicles with estimated or predicted wireless connectivity that is sufficient for the respective applications or services used during the journey, without possibly overloading the capacity of the wireless connection along any of the routes. The route of vehicle 3 is chosen so as to provide sufficient estimated or predicted QoE for the two services or applications that are active throughout the journey. The final route segment for vehicles 1 and 3 is identical, as its wireless connection supports sufficient QoE for the services or applications active in both vehicles. The service indicated by the vertical-line pattern may not be available along this last route segment, but this is not a problem since that service was terminated according to a schedule in vehicle 1 prior to reaching this last route segment. The route of vehicle 4 likewise follows a path that ensures that the one service or application that is active throughout the entire journey has a QoE that is sufficiently high, and that there is no other vehicle competing over limited wireless resources or capacity.

The concept explained with reference to FIG. 7 does not necessarily rely on static QoE data for the route segments. As the vehicles are connected wirelessly anyway, they can provide feedback to the server that stores QoE historic data and estimates or predicts QoE data for route segments of planned routes. The feedback may be provided in real-time, or near-real-time, which allows for quickly updating routes for vehicles that have not yet started or have not finished their journey. However, any feedback will improve prediction and estimation, notably when enriched and time- and location-linked with other data.

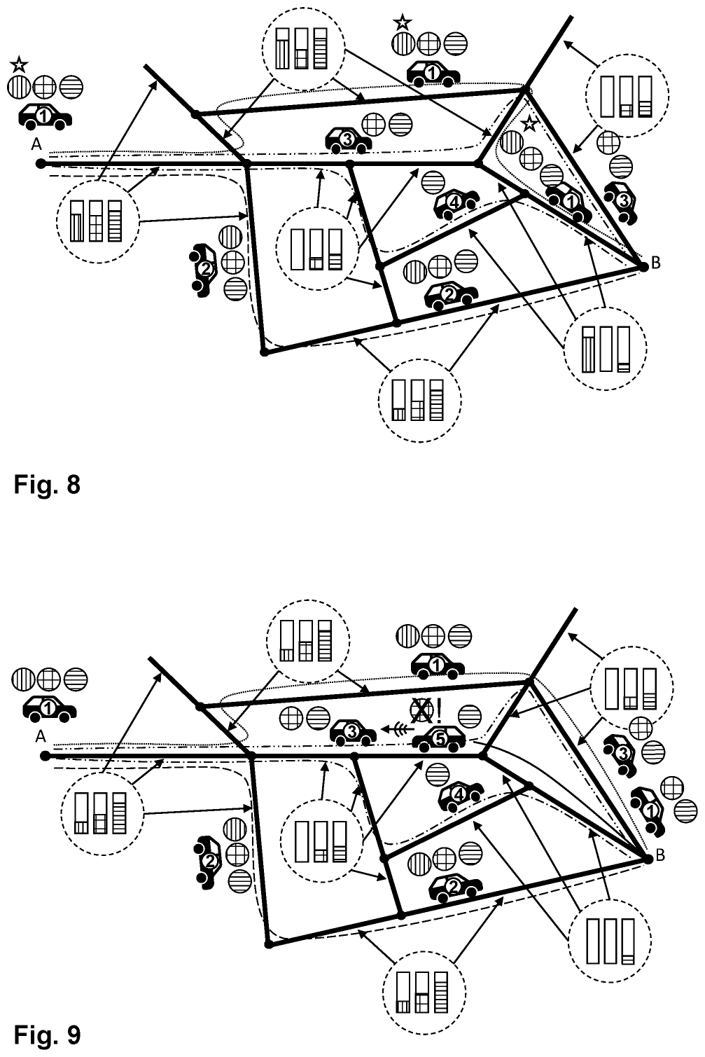

FIG. 8 shows the functioning of the invention in a second simplified, schematic and diagrammatic real-word example. The second example is similar to the first one discussed with reference to FIG. 7. However, in the second example one or more services or applications active in a vehicle during the journey may be prioritized by a user. In this case, the route may be selected so as to ensure as best as possible that the QoE of a prioritized service or application remains sufficiently high during the entire journey, even if the QoE for another service or application may fall below a desirable level or a service or application may become temporarily unavailable. In the figure, vehicles 2, 3, and 4 follow the same paths as in FIG. 7 under the same conditions. However, vehicle 1, in which the service or application represented by the vertical-line pattern is set as a prioritized service or application, indicated by the star, follows a different route than in FIG. 7. The final route segment is modified so as to ensure that the prioritized service or application is available at the required QoE level. While it could have been possible to follow the same route as vehicle 2, the QoE level along this route does not meet the QoE requirements of the service or application of vehicle 1, indicated by the different height of the bar-graphs for the respective routes. In this example, the service or application represented by the crossed-line pattern is unavailable along the last two route segments, which may be acceptable according to the user preferences of vehicle 1.

FIG. 9 shows the functioning of the invention in a third simplified, schematic and diagrammatic real-world example. The third example is similar to the first one discussed with reference to FIG. 7. However, in the third example information about QoE along route segments may be locally shared amongst vehicles or locally provided through road side units, or RSUs. This may result in a faster exchange of QoE information for route segments, which in turn may lead to faster update of routes, if required. In this example, vehicle 5 travels from point B to point A and encounters vehicle 3 at some point in between. The route of vehicle 3 may initially have been the same as that of vehicle 5, only in the opposite direction. However, vehicle 5 transmits QoE data to vehicle 3 that indicates that the service represented by the cross-line pattern is unavailable on the route segment it has just passed, as indicated by the crossed-out service and the exclamation mark. Vehicle 3 may then contact the cloud-based server, or use information previously received and stored, for changing the route, using route segments that provide a sufficient QoE for the services or applications that are active in vehicle 3. The local information exchange may also be provided through RSUs. In this case, vehicles passing a RSU may transmit QoE information collected during their travel, along with the road segments to which they pertain, and the information may be stored and available for a certain time or until replaced by updated information. Updated information may also be provided to the RSUs through a backbone link from the cloud-based server.

While embodiments of the invention have been described hereinbefore with a focus on vehicle navigation systems it is readily apparent that the expression vehicle may be used synonymously for any moving entity that uses some kind of connected navigation device. In this regard the service used for determining the location is irrelevant, and not limited to the “classic” geo-location services such as GPS, Galileo, Baidu, GLONASS and the like, but may also include indoor navigation using other technologies, e.g., Bluetooth or Wi-Fi-based indoor navigation, as may be found in larger building complexes. The invention may, thus, also include a mobile navigation device, such as a smartphone or similar device, used by a pedestrian for finding a route in a pedestrian zone of a city or inside a building. Likewise, it is readily apparent that the wireless connectivity on which a service or application relies is not limited to “classic” cell phone connectivity, i.e., 3G, 4G, 5G and the like, but may also include local wireless networks such as publicly accessible Wi-Fi networks etc.

### LIST OF REFERENCE NUMERALS (PART OF THE DESCRIPTION)

1-4 vehicles
100 determining/modifying route
110 determining>1 route candidate
112 accessing road database
114 transmitting first location &
Destination
116 receiving>1 route candidate
120 assigning>1 first values
122 retrieve first values
124 receive first values
130 selecting preferred route
200 operating navigation system
210 receiving route candidates
220 retrieving user preferences
230 mapping
232 retrieve further criteria
234 manual selection input
236 retrieve application or service rank
240 prioritize or select
500 mobile navigation system
502 microprocessor
504 volatile memory
506 non-volatile memory
508 communication interface
510 geo-location
512 data connection or bus

1. A method of generating and providing one or more routes for a first mobile user between a first location and a destination (B), comprising:
composing, based on data representing roads or paths between the first location and the destination, at least one route candidate, wherein the at least one route candidate comprises at least one route segment,
characterized in that the method further comprises:
assigning, to each of the at least one route segments of the at least one route candidate, one or more first values representing an estimated or predicted Quality of Experience (QoE) for one or more corresponding services or applications, executed or provided by one or more devices installed at or located with the first mobile user, whose function is dependent on data that is wirelessly received in real-time or near real-time, and
processing, in a navigation system of the first mobile user, or providing to the navigation system of the first mobile user, the one or more route candidates along with the one or more assigned first values, for selection and/or execution.

2. The method of claim 1 wherein composing the at least one route candidate comprises:
accessing a database storing data representing roads, the database being local to the first mobile user, and determining at least one route candidate between the first location and the destination, or
transmitting the first location and the destination to a computer that is remote to the first mobile user and that has access to a database storing data representing roads, and that is configured to compose at least one route candidate between the first location and the route destination, and
receiving at least one route candidate.

3. The method of claim 1 wherein the step of assigning first values representing an estimated or predicted QoE for one or more corresponding services or applications comprises:
retrieving, from a database or a cloud service, corresponding first values representing an estimated or predicted QoE for the candidate routes or segments thereof, for one or more services or applications, and/or
receiving, from a local contributor, first values representing an estimated or predicted QoE for one or more route segments in an area ahead of or around a current location of the first mobile user, for one or more services or applications.

4. The method of claim 3, further comprising:
receiving the two or more route candidates along with the one or more assigned first values in the first mobile user's navigation system,
retrieving user preferences for an application or service that is or will be active while the first mobile user is travelling towards the destination,
mapping the respective user preferences for the application or service against the first values for each of the received route candidates, and
prioritizing or selecting that route candidate as preferred route for which the first values of the largest number of route segments meet or exceed the corresponding information provided in the user preferences.

5. The method of claim 4 wherein, in case more than one service or application that is executed or provided by a device installed at or located with the first mobile user and whose functions are dependent on data that is received in real-time or near real-time are active in parallel, prioritizing or selecting the preferred route from the route candidates comprises:
retrieving or receiving ranks or weights associated with each of the services or applications that are active in parallel, and
prioritizing or selecting the route candidate, for which the value representing the estimated or predicted QoE for the service or application having the highest rank or weight has the highest value, as the preferred route.

6. The method of claim 5 wherein a route candidate or a route segment whose first value for a service or application lies below a predetermined minimum value is discarded irrespective of the rank or weight assigned to the service or application.

7. The method of claim 6 wherein operating the first mobile user's navigation system for prioritizing or selecting a preferred route from the route candidates further comprises:
retrieving one or more additional, non-QoE-related prioritizing or selection criteria from stored or otherwise received user preferences, for use and consideration during the prioritizing and/or selection step.

8. The method of claim 7 wherein operating the first mobile user's navigation system for prioritizing or selecting a preferred route from the route candidates further comprises:
retrieving a user-priority value for each one of a plurality of user devices installed at or located with the first mobile user, for use and consideration during the prioritizing and/or selection step.

9. The method of claim 8 wherein operating the first mobile user's navigation system for prioritizing and/or selecting a preferred route from the route candidates further comprises:
receiving, for each route candidate or segment thereof, one or more first values for one or more corresponding services or applications,
retrieving data pertaining to the wireless capabilities of devices installed at or located with the first mobile user and pertaining to the services or applications that can be provided or executed by the respective devices, and
weighting the first values for one or more services or applications in accordance with the wireless capabilities of the respective device that provides or executes the respective service or application, and/or
determining which device provides or executes which service or application based on the data pertaining to the wireless capabilities.

10. The method of claim 9 wherein individual first values for one or more services or applications are associated with routes or route segments in accordance with service levels or service- or application-specific profiles, wherein operating the first mobile user's navigation system for prioritizing and/or selecting preferred route from the route candidates further comprises:
retrieving, for one or more services or applications, service levels and/or application-specific profiles,
selecting, for each received route candidate or segment thereof, one or more first values in accordance with a service level and/or a service- or application-specific profile of the respective services or applications that are or will be active while the first mobile user has not yet reached the destination, for use and consideration during the prioritizing and/or selection step.

11. The method of claim 10 further comprising:
retrieving or receiving, while the first mobile user has not yet reached the destination, updated information pertaining to first values representing estimated or predicted QoE for one or more corresponding services or applications for route segments lying between a current location of the first mobile user and the destination,
repeating the determining step, and/or
repeating the assigning step using the updated information, and
repeating the prioritizing and/or selecting step, for prioritizing and/or selecting an updated preferred route.

12. A mobile navigation system comprising: a microprocessor, a volatile memory, a non-volatile memory, and at least one communication interface, which are communicatively connected via at least one data connection or bus, wherein the non-volatile memory stores computer program instructions which, when executed by the microprocessor, cause the mobile navigation system to perform operations for generating and providing one or more routes for a first mobile user between a first location and a destination, comprising:
composing, based on data representing roads or paths between the first location and the destination, at least one route candidate, wherein the at least one route candidate comprises at least one route segment,
assigning, to each of the at least one route segments of the at least one route candidate, one or more first values representing an estimated or predicted Quality of Experience (QoE) for one or more corresponding services or applications, executed or provided by one or more devices installed at or located with the first mobile user, whose function is dependent on data that is wirelessly received in real-time or near real-time, and
processing, in a navigation system of the first mobile user, or providing to the navigation system of the first mobile user, the one or more route candidates along with the one or more assigned first values, for selection and/or execution.

13. A method of determining one or more first values representing an estimated or predicted QoE for a service or application for a route segment, comprising:
receiving, from a plurality of devices that are executing or providing, or had executed or provided, one or more services or applications, values or data representing a QoE pertaining to corresponding services or applications for a route segment or for locations along the route segment, and optionally receiving meta-information from the plurality of devices, and
analyzing and merging the values or data received from a plurality of devices and, if available, the optionally received data and other information into classified sets of QoE values.

14. The method of claim 13 further comprising:
determining a number of mobile users or devices that retrieve first values representing an estimated or predicted QoE for one or more services or applications and that are or are expected to be travelling route segments at the same time or within a predetermined time window,
wherein analyzing and merging further comprises:
reducing a predicted or estimated QoE for one or more service levels, wireless providers, device and/or transceiver types, of one or more services or applications for a route segment for which the number of mobile users that are or are expected to be traveling at the same time or within a predetermined time window exceeds a predetermined value.

15. A computer system having access to a database storing road or path data and being wirelessly connectable with a plurality of mobile users or devices that are configured to transmit localized and time-stamped feedback pertaining to experienced, perceived or algorithmically determined QoE of one or more services or applications, the feedback being collected while travelling along route segments of a route, wherein the computer system is configured to perform operations for determining one or more first values representing an estimated or predicted QoE for a service or application for a route segment, comprising:
receiving, from a plurality of devices that are executing or providing, or had executed or provided, one or more services or applications, values or data representing a QoE pertaining to corresponding services or applications for a route segment or for locations along the route segment, and optionally receiving meta-information from the plurality of devices, and
analyzing and merging the values or data received from a plurality of devices and, if available, the optionally received data and other information into classified sets of QoE values.

16. (canceled)

17. (canceled)

18. (canceled)

19. (canceled)
